(19) United States
(12) Patent Application Publication
(10) Pub. No.: US 2013/0105742 A1
(43) Pub. Date: May 2, 2013

(54) Impregnated Yttric or Gadolinium-Containing Barium-Aluminum-Scandate Cathodes and Their Fabrication Methods

(71) Applicants: Jinshu Wang, Beijing (CN); Wei Liu, Beijing (CN); Fan Yang, Beijing (CN); Xiang Liu, Beijing (CN); Hongyi Li, Beijing (CN); Meiling Zhou, Beijing (CN); Tieyong Zuo, Beijing (CN)

(72) Inventors: Jinshu Wang, Beijing (CN); Wei Liu, Beijing (CN); Fan Yang, Beijing (CN); Xiang Liu, Beijing (CN); Hongyi Li, Beijing (CN); Meiling Zhou, Beijing (CN); Tieyong Zuo, Beijing (CN)

(73) Assignee: BEIJING UNIVERSITY OF TECHNOLOGY, Beijing (CN)

(21) Appl. No.: 13/340,701

(22) Filed: Dec. 30, 2011

(30) Foreign Application Priority Data
Nov. 2, 2011 (CN) 201110341108.3

(51) Int. Cl. H01B 1/08; B28B 3/00; B28B 11/00; B05D 5/12

(52) U.S. Cl. 252/515; 252/521.1; 427/126.3; 264/109

(57) ABSTRACT

Impregnated rare earth metal-containing barium-aluminum-scandate cathodes with a rare earth oxide doped tungsten matrix and methods for the fabrication thereof are described. In one aspect, an impregnated rare earth metal-containing barium-aluminum-scandate cathode comprises: a rare earth oxide doped tungsten matrix, and an impregnated active substance. The active substance comprises scandium oxide (Sc₂O₃), a second rare earth oxide, and barium calcium aluminate, wherein the molar ratio of Ba:Ca:Al is about 4:1:1.

### CROSS-REFERENCE TO RELATED APPLICATION

This application claims priority to Chinese Patent Application No. 201110341108.3, filed Nov. 2, 2011, which is incorporated in its entirety herein by reference.

### TECHNICAL FIELD

The present disclosure relates to a method of manufacturing an impregnated yttric or gadolinium-containing Barium-aluminum-scandate cathode with yttrium oxide/gadolinium oxide-tungsten matrix, which belongs to the technical field of rare earth-refractory metal cathodes.

### BACKGROUND OF RELATED ART

Magnetrons, as an important kind of high power microwave devices, have a wide range of applications in many fields, such as military, medical and civil fields. As one of the key components of the magnetron, the cathode plays an important role in the operation of magnetrons. In order to develop high-power and high-frequency magnetrons, the cathodes are needed to have a certain thermionic emission and excellent secondary electron emission properties. Currently, Ba—W dispenser cathodes are generally used in the commercial magnetrons. However, Ba—W dispenser cathodes can not fulfill the requirements of the high power magnetrons due to their bad anti-bombarding insensitivity and poor secondary emission yields. It has been shown that REO-Mo cathodes exhibit an excellent secondary emission property and good anti-bombarding insensitivity. However, their low thermionic emission current density still limits their applications in the high power magnetrons. Therefore, there remains a need for developing a new type of cathodes possessing all desired properties for high power and millimeter-wave magnetron applications.

### SUMMARY

The present disclosure provides an impregnated rare earth containing Barium aluminum-scandate cathode with a rare earth oxide doped tungsten matrix and methods for the fabrication.

In one aspect, an impregnated rare earth-containing Barium-aluminum-scandate cathode may comprise a first rare earth oxide doped tungsten matrix; and an impregnated active substance. The impregnated active substance may comprise scandium oxide (Sc₂O₃), a second rare earth oxide, and Barium-calcium-aluminate, wherein the molar ratio of Ba:Ca:Al is about 4:1:1.

In some embodiments, the concentration of the first rare earth oxide in the matrix ranges from 3 to 10% by weight.

In some embodiments, the first rare earth oxide in the matrix is yttrium oxide (Y₂O₃) or gadolinium oxide (Gd₂O₃).

In some embodiments, the concentration of the Sc₂O₃ in the impregnated active substance ranges from 2 to 6% by weight.

In some embodiments, the concentration of the second rare earth oxide in the impregnated active substance ranges from 3 to 5% by weight.

In some embodiments, the second rare earth oxide in the impregnated active substance is Y₂O₃, or Gd₂O₃.

In another aspect, an impregnated rare earth-containing Barium-aluminum-scandate cathode may comprise a first rare earth oxide doped tungsten matrix; and an impregnated active substance that comprises scandium oxide (Sc₂O₃), a second rare earth oxide, and Barium-calcium-aluminate; wherein the first and the second rare earth oxides are yttrium oxide (Y₂O₃) or gadolinium oxide (Gd₂O₃);

In some embodiments, the concentration of the first rare earth oxide in the matrix ranges from 3 to 10% by weight.

In some embodiments, the impregnated active substance comprises 2 to 6% in weight of Sc₂O₃, 3 to 5% by weight of Y₂O₃ or Gd₂O₃, and Barium-calcium-aluminate in the molar ratio of Ba:Ca:Al of 4:1:1.

In another aspect, a method for making the impregnated rare earth-containing Barium-aluminum-scandate cathodes may comprises: mixing a rare earth oxide with a tungsten powder; pressing the mixed powder into pellets under a pressure between 1.5 t/cm² to 4 t/cm²; sintering the pellet under hydrogen at a temperature between 1500° C. and 1600° C. for 10 to 20 minutes to obtain a matrix; dissolving a raw material comprising scandium nitrate, Barium nitrate, calcium nitrate, aluminum nitrate, and rare earth nitrate in de-ionized water to obtain a raw material solution; titrating an excess amount of aqueous ammonium carbonate solution into the raw material solution until all cations are precipitated out; leaching the precipitated solid; drying the solid; calcining the dried solid under air/oxygen at a temperature between 650° C. and 950° C. for 2 to 5 hours; reacting the calcined solid under dry hydrogen at a temperature between 1500° C. and 1600° C. for 10 to 30 minutes to obtain an impregnated active substance; and impregnating the active substance into the matrix under hydrogen at a temperature between 1600° C. and 1650° C. for 1 to 3 minutes.

In some embodiments, the concentration of the rare earth oxide in the matrix ranges from 3 to 10% by weight.

In some embodiments, the rare earth oxide in the matrix is yttrium oxide (Y₂O₃) or gadolinium oxide (Gd₂O₃).

In some embodiments, the rare earth nitrate is yttrium nitrate, or gadolinium nitrate.

In some embodiments, the raw materials correspond to 2 to 6% by weight of Sc₂O₃, 3 to 5% by weight of Y₂O₃ or Gd₂O₃, and Barium-calcium-aluminates in the molar ratio of Ba:Ca:Al of 4:1:1.

In another aspect, a method for making a rare earth oxide doped tungsten matrix may comprise: mixing a rare earth oxide power and a tungsten powder; pressing the mixed powders into pellets; and sintering the pellet to obtain a matrix.

In some embodiments, the concentration of the rare earth oxide ranges from 3 to 10% by weight.

In some embodiments, the rare earth oxide powder and the tungsten power are mixed by mechanical mixing method.

In some embodiments, the rare earth oxide is yttrium oxide (Y₂O₃), or gadolinium oxide (Gd₂O₃).

In some embodiments, the mixed powders are pressed under a pressure between 1.5 t/cm² to 4 t/cm² to form pellets.

In some embodiments, the pellet is sintered under hydrogen at a temperature between 1500° C. and 1600° C. for 10 to 20 minutes.

In another aspect, a method for making an impregnated active substance may comprise: dissolving raw materials comprising scandium nitrate, barium nitrate, calcium nitrate, aluminum nitrate, and rare earth nitrate in de-ionized water to obtain a raw material solution; titrating an excess amount of aqueous ammonium carbonate solution into the raw material solution until all cations are precipitated out; leaching the precipitated solid from the solution; drying the solid; calcining the dried solid; and reacting the calcined solid under dry hydrogen to form an impregnated active substance.

In some embodiments, the rare earth nitrate is yttrium nitrate, or gadolinium nitrate.

In some embodiments, the raw materials correspond to 2 to 6% by weight of Sc₂O₃, 3 to 5% by weight of Y₂O₃ or Gd₂O₃, and Barium-calcium-aluminate in the molar ratio of Ba:Ca:Al of 4:1:1

In some embodiments, the solid is calcined under air/oxygen at a temperature between 650° C. and 950° C. for 2 to 5 hours

In some embodiments, the solid is reacted under dry hydrogen at temperatures between 1500° C. and 1600° C. for 10 to 30 minutes.

In yet another aspect, a method for making an impregnated rare earth-containing Barium-aluminum-scandate cathode with a rare earth oxide doped tungsten matrix may comprises impregnating the active substance into the rare earth oxide doped tungsten matrix under hydrogen at a temperature between 1600° C. and 1650° C. for 1 to 3 minutes.

Thus, the present disclosure provides a method for fabricating an impregnated yttric or gadolinium-containing Barium-aluminum-scandate cathode with yttrium oxide (Y₂O₃)/gadolinium oxide (Gd₂O₃)-tungsten (W) matrix. The rare earth oxide Y₂O₃/Gd₂O₃ is doped into the matrix, and then the yttric or gadolinium-containing Barium-aluminum-scandate is impregnated into the matrix above in order to enhance the thermionic emission and secondary emission properties of the cathode.

There are a number of advantages provided by the techniques of the present disclosure. The impregnated yttric or gadolinium-containing Barium-aluminum-scandate cathode with yttrium oxide/gadolinium oxide-tungsten matrix provided by this present disclosure exhibits excellent secondary emission performance, i.e., the maximum secondary emission yield δₘₐₓ of the cathode with 10 wt % content of Y₂O₃ in the matrix is 3.51, and the thermionic emission current density of this cathode at 900° C. can reach 20.99 A/cm² after being activated. The maximum secondary emission yield δₘₐₓ of the cathode with 10 wt % content of Gd₂O₃ in the matrix is 3.87, and the thermionic emission current density of this cathode at 900° C. can reach 19.36 A/cm² after being activated. The performance of these two kinds of cathodes is better than that of Ba—W dispenser cathode used in the commercial magnetrons at present, which makes it possible for the practical application.

### BRIEF DESCRIPTION OF THE DRAWINGS

The techniques of the present disclosure will now be described in detail with reference to the accompanying drawings.

FIG. 1 is a flow diagram of one illustrated method for making an impregnated rare earth-containing Barium-aluminum-scandate cathode with a rare earth oxide doped tungsten matrix.

FIG. 2 is a flow diagram of one illustrated method for making a rare earth oxide doped tungsten matrix.

FIG. 3 is a flow diagram of one illustrated method for making an impregnated active substance.

FIG. 4 is a graph of voltage versus current density curves of a cathode as illustrated in Example 1 with 3 wt % of Y₂O₃ in the matrix which is sintered in the atmosphere of hydrogen at 1500° C. for 10 minutes. The impregnated active substance contains 3 wt % of Sc₂O₃, 5 wt % of Y₂O₃ and 92 wt % of Barium-calcium-aluminate in the molar ratio of Ba:Ca:Al of 4:1:1.

FIG. 5 is a graph of voltage versus current density curves of a Ba—W dispenser cathode at different temperatures after being activated.

FIG. 6 is a graph of energy versus secondary emission yield curves of a cathode as illustrated in Example 5 with 10 wt % of Y₂O₃ in the tungsten matrix which is sintered in the atmosphere of hydrogen at 1550° C. for 10 minutes. The impregnated active substance contains 6 wt % of Sc₂O₃, 3 wt % of Y₂O₃ and 91 wt % of Barium-calcium-aluminate in the molar ratio of Ba:Ca:Al of 4:1:1.

FIG. 7 is a graph of energy versus secondary emission yield curves of a Ba—W dispenser cathode activated at different temperatures.

### DETAILED DESCRIPTION OF THE PREFERRED EMBODIMENTS

In the following description, impregnated rare earth-containing Barium-aluminum-scandate cathodes with a rare earth oxide doped tungsten matrices are obtained according to the present disclosure.

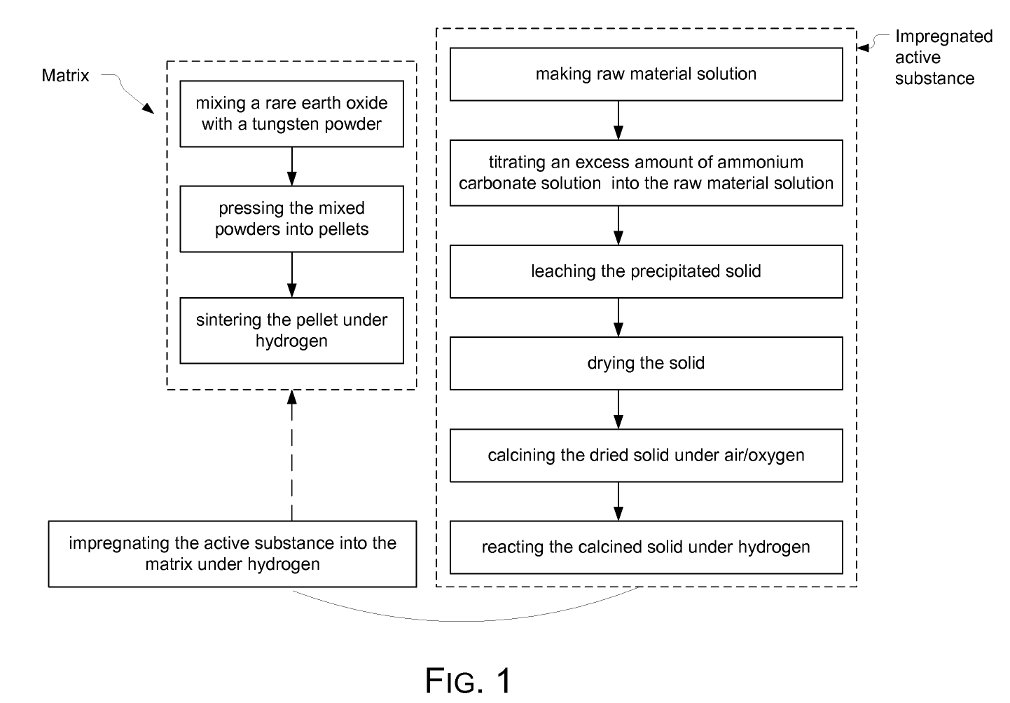

FIG. 1 is a flow diagram of one illustrated method for making an impregnated rare earth-containing Barium-aluminum-scandate cathode with a rare earth oxide doped tungsten matrix. Referring to FIG. 1, first, the rare earth oxide is mixed with the tungsten powders by a mechanical mixing method with 3 to 10 wt % of rare earth oxide. The mixed powders are then pressed into pellets at a pressure between 1.5 t/cm² to 4 t/cm². The pellet is sintered under hydrogen at a temperature between 1500° C. and 1600° C. for 10 to 20 minutes to form a rare earth oxide doped tungsten matrix. Secondly, rare earth nitrate (e.g., Y(NO₃)₃.xH₂O or Gd(NO₃)₃.xH₂O), scandium nitrate (Sc(NO₃)₃.xH₂O), barium nitrate Ba(NO₃)₂, calcium nitrate (Ca(NO₃)₂.xH₂O), aluminum nitrate (Al(NO₃)₃.xH₂O) are dissolved in the de-ionized water, respectively, to obtain a raw material solution, and then an excess amount of aqueous ammonium carbonate(NH₄)₂CO₃ solution is titrated into the raw material solution until all cations are precipitated out. In the above molecular formulas, “x” is a positive integer, including zero, representing the number of crystal water in the molecule. Scandium nitrate, yttrium nitrate, gadolinium nitrate, calcium nitrate, and aluminum nitrate with various numbers of crystal water or without crystal water can be used in the present disclosure as the raw materials. The raw solution corresponds to 2-6 wt % of Sc₂O₃, 3-5 wt % of Y₂O₃/Gd₂O₃ and the rest of BaO, CaO and Al₂O₃ having molar ratio of Ba:Ca:Al of 4:1:1. After leaching and drying of the precipitates, the dried solid is calcined under air/oxygen at temperatures between 650° C. and 950° C. for 2 to 5 hours and then reacted under dry hydrogen at temperatures between 1500° C. and 1600° C. for 10 to 30 minutes to obtain the impregnated rare earth-containing Barium-aluminum-scandate active substance. Finally, the active substance is impregnated into the matrix under hydrogen at a temperature between 1600° C. and 1650° C. for 1 to 3 minutes to form an impregnated rare earth-containing Barium-aluminum-scandate cathode with a rare earth oxide doped tungsten matrix.

In some embodiments, the rare earth oxide is yttrium oxide (Y₂O₃), or gadolinium oxide (Gd₂O₃).

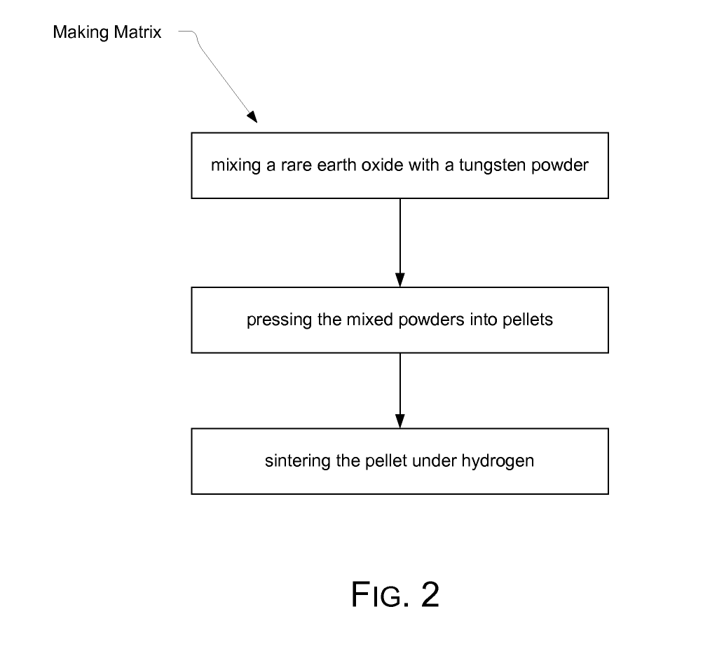

FIG. 2 is a flow diagram of one illustrated method for making a rare earth oxide doped tungsten matrix. Referring to FIG. 2, the rare earth oxide is first mixed with the tungsten powders. The mixed powders then are pressed into pellets. The pellet is finally sintered to form a rare earth oxide doped tungsten matrix.

In some embodiments, the concentration of the rare earth oxide ranges from 3 to 10 wt %.

In some embodiments, the rare earth oxide powder and the tungsten power are mixed by mechanical mixing method.

In some embodiments, the rare earth oxide is yttrium oxide (Y₂O₃), or gadolinium oxide (Gd₂O₃).

In some embodiments, the mixed powders are pressed under a pressure between 1.5 t/cm² to 4 t/cm² to form pellets.

In some embodiments, the pellet is sintered under hydrogen at a temperature between 1500° C. and 1600° C. for 10 to 20 minutes.

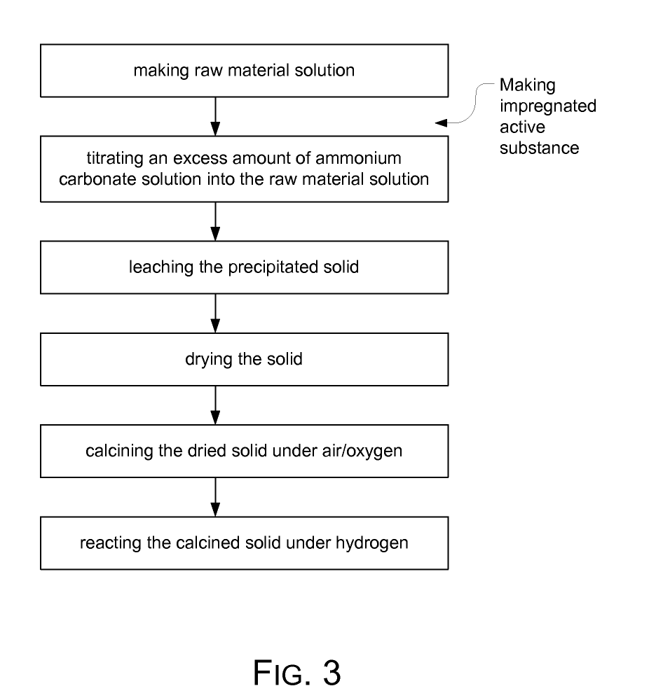

FIG. 3 is a flow diagram of one illustrated method for making an impregnated active substance. Referring to FIG. 3, rare earth nitrate, scandium nitrate, barium nitrate, calcium nitrate, aluminum nitrate are dissolved in the de-ionized water, respectively, to obtain a raw material solution, and an excess amount of aqueous ammonium carbonate(NH₄)₂CO₃ solution is then titrated into the raw solution until all cations are precipitated out. After leaching and drying of the precipitates, the dried solid is calcined under air/oxygen and then reacted under dry hydrogen to obtain an impregnated rare earth-containing Barium-aluminum-scandate active substance.

In some embodiments, the rare earth nitrate is yttrium nitrate, or gadolinium nitrate.

In some embodiments, the raw materials correspond to 2 to 6 wt % of Sc₂O₃, 3 to 5 wt % of Y₂O₃ or Gd₂O₃, and Barium-calcium-aluminate in the molar ratio of Ba:Ca:Al of 4:1:1

In some embodiments, the solid is calcined under air/oxygen at a temperature between 650° C. and 950° C. for 2 to 5 hours

In some embodiments, the solid is reacted under dry hydrogen at temperatures between 1500° C. and 1600° C. for 10 to 30 minutes.

An impregnated rare earth-containing Barium-aluminum-scandate cathode with a rare earth oxide doped tungsten matrix can be obtained by impregnating the active substance into the rare earth oxide doped tungsten matrix under hydrogen at a temperature between 1600° C. and 1650° C. for 1 to 3 minutes.

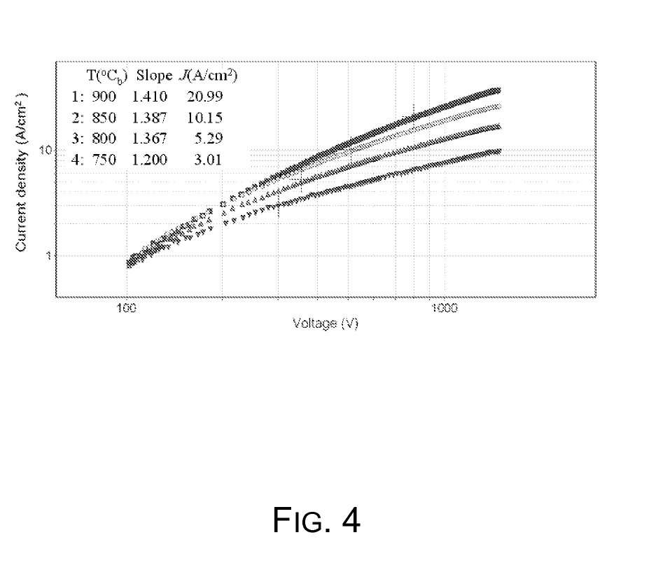

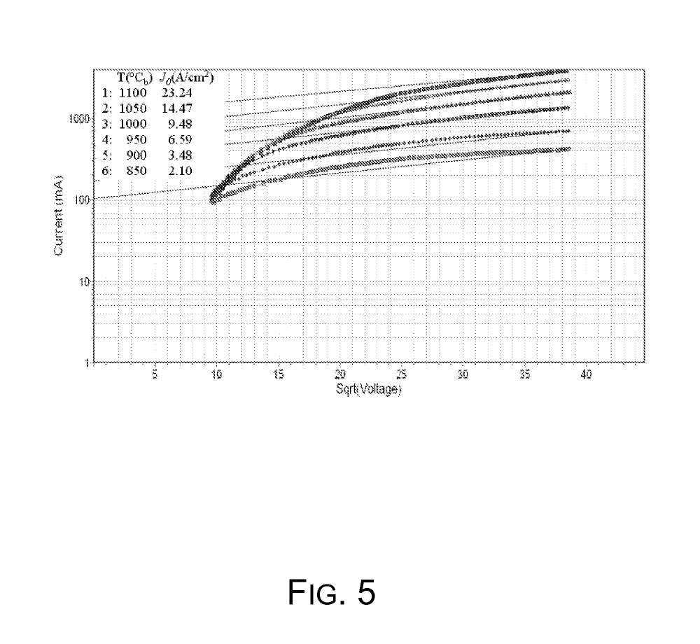

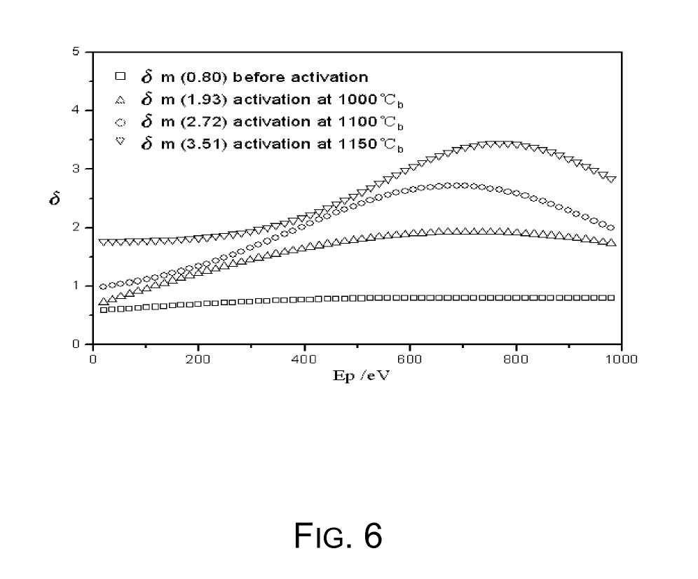

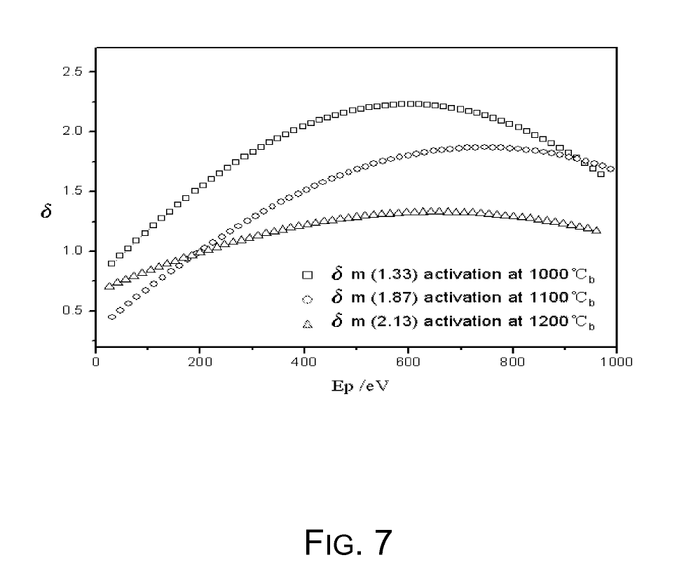

The performance of rare earth-containing Barium-aluminum-scandate cathodes according to the present disclosure is evaluated and compared with that of conventional Ba—W dispenser cathode (FIG. 4-7, Table 1). The impregnated yttric or gadolinium-containing Barium-aluminum-scandate cathodes with yttrium oxide or gadolinium oxide doped tungsten matrices exhibit excellent secondary emission performance. As shown in FIG. 6, the maximum secondary emission yield δₘₐₓ of a cathode with 10 wt % Y₂O₃ doped in the tungsten matrix is 3.51, and its thermionic emission current density at 900° C. can reach 20.99 A/cm² after being activated. The maximum secondary emission yield δₘₐₓ of a cathode with 10 wt % of Gd₂O₃ doped in the tungsten matrix is 3.87, and the thermionic emission current density of this cathode at 900° C._{b} can reach 19.36 A/cm² after being activated. The impregnated yttric or gadolinium-containing Barium-aluminum-scandate cathodes show much enhanced secondary emission yield and thermionic emission current density comparing to Ba—W dispenser cathodes that are currently used in the commercial magnetrons, which makes them a promising candidate for high power magnetron applications.

### EXAMPLES

### Example 1

0.90 g of Y₂O₃ and 29.10 g of W powders were mixed by a mechanical mixing method, and then the powders were pressed into the pellets with the size of φ3×1.5 mm under the pressure of 4 t/cm². Finally, the pellets were sintered in the atmosphere of hydrogen at 1500° C. for 10 minutes and shaped into the matrices needed. The aqueous solution of 3.11 g of Y(NO₃)₃.4H₂O, 2.17 g of Sc(NO₃)₃.4H₂O, 24.94 g of Ba(NO₃)₂, 5.63 g of Ca(NO₃)₂.4H₂O, 17.90 g of Al(NO₃)₃9H₂O and 22.00 g of (NH₄)₂CO₃ was dissolved in the de-ionized water, respectively. The aqueous solution of nitric salt prepared in the first step was mixed together, and then excessive ammonium carbonate solution was titrated into the mixed aqueous solution until all cations are precipitated out. After leaching and drying, the powders were calcined in the atmosphere of air/oxygen at 650° C. for 2 h, and then reacted in the dry hydrogen at 1500° C. for 10 minutes to obtain the active substance which is subsequently impregnated into the matrices above at the temperature of 1600° C. for 1 minute, thus the impregnated yttric Barium-aluminum-scandate cathodes with yttrium oxide-tungsten matrices were obtained.

### Example 2

1.50 g of Y₂O₃ and 28.50 g of W powders were mixed by a mechanical mixing method, and then the powders were pressed into the pellets with the size of φ10×1.5 mm under the pressure of 3 t/cm². Finally, the pellets were sintered in the atmosphere of hydrogen at 1550° C. for 15 minutes and shaped into the matrices needed. The aqueous solution of 1.86 g of Y(NO₃)₃.4H₂O, 1.44 g of Sc(NO₃)₃.4H₂O, 25.75 g of Ba(NO₃)₂, 5.82 g of Ca(NO₃)₃.4H₂O, 18.48 g of Al(NO₃)₃.9H₂O, and 22.00 g of (NH₄)₂CO₃ was dissolved in the de-ionized water, respectively. The aqueous solution of nitric salt prepared in the first step was mixed together, and then excessive ammonium carbonate solution was titrated into the mixed aqueous solution until all cations are precipitated out. After leaching and drying, the powders were calcined in the atmosphere of air/oxygen at 750° C. for 3 h, and then reacted in the dry hydrogen at 1550° C. for 20 minutes to obtain the active substance which is subsequently impregnated into the matrices above at the temperature of 1650° C. for 2 minutes, thus the impregnated yttric Barium-aluminum-scandate cathodes with yttrium oxide-tungsten matrices were obtained.

### Example 3

2.10 g of Y₂O₃ and 27.90 g of W powders were mixed by a mechanical mixing method, and then the powders were pressed into the pellets with the size of φ10×1.5 mm under the pressure of 2 t/cm². Finally, the pellets were sintered in the atmosphere of hydrogen at 1600° C. for 20 minutes and shaped into the matrix needed. The aqueous solution of 2.49 g of Y(NO₃)₃.4H₂O, 2.89 g of Sc(NO₃)₃.4H₂O, 24.94 g of Ba(NO₃)₂, 5.63 g of Ca(NO₃)₃.4H₂O, 17.90 g of Al(NO₃)₃.9H₂O and 22.00 g of (NH₄)₂CO₃ was dissolved in the de-ionized water, respectively. The aqueous solution of nitric salt prepared in the first step was mixed together, and then excessive ammonium carbonate solution was titrated into the mixed aqueous solution until all cations are precipitated out. After leaching and drying, the powders were calcined in the atmosphere of air/oxygen at 850° C. for 4 h, and then reacted in the dry hydrogen at 1600° C. for 30 minutes to obtain the active substance which is subsequently impregnated into the matrices above at the temperature of 1650° C. for 3 minutes, thus the impregnated yttric Barium-aluminum-scandate cathodes with yttrium oxide-tungsten matrices were obtained.

### Example 4

2.70 g of Y₂O₃ and 27.30 g of W powders were mixed by a mechanical mixing method, and then the powders were pressed into the pellets with the size of φ10×1.5 mm under the pressure of 1.5 t/cm². Finally, the pellets were sintered in the atmosphere of hydrogen at 1500° C. for 15 minutes and shaped into the matrices needed. The aqueous solution of 2.49 g of Y(NO₃)₃.4H₂O, 3.61 g of Sc(NO₃)₃.4H₂O, 24.66 g of Ba(NO₃)₂, 5.57 g of Ca(NO₃)₃.4H₂O, 17.70 g of Al(NO₃)₃.9H₂O and 22.00 g of (NH₄)₂CO₃ was dissolved in the de-ionized water, respectively. The aqueous solution of nitric salt prepared in the first step was mixed together, and then excessive ammonium carbonate solution was titrated into the mixed aqueous solution until all cations are precipitated out. After leaching and drying, the powders were calcined in the atmosphere of air/oxygen at 950° C. for 5 h, and then reacted in the dry hydrogen at 1500° C. for 20 minutes to obtain the active substance which is subsequently impregnated into the matrices above at the temperature of 1650° C. for 1 minute, thus the impregnated yttric Barium-aluminum-scandate cathodes with yttrium oxide-tungsten matrices were obtained.

### Example 5

3.00 g of Y₂O₃ and 27.00 g of W powders were mixed by a mechanical mixing method, and then the powders were pressed into the pellets with the size of φ10×1.5 mm under the pressure of 4 t/cm². Finally, the pellets were sintered in the atmosphere of hydrogen at 1550° C. for 10 minutes and shaped into the matrices needed. The aqueous solution of 1.86 g of Y(NO₃)₃.4H₂O, 4.33 g of Sc(NO₃)₃.4H₂O, 24.66 g of Ba(NO₃)₂, 5.57 g of Ca(NO₃)₂.4H₂O, 17.70 g of Al(NO₃)₃.9H₂O and 22.00 g of (NH₄)₂CO₃ was dissolved in the de-ionized water, respectively. The aqueous solution of nitric salt prepared in the first step was mixed together, and then excessive ammonium carbonate solution was titrated into the mixed aqueous solution until all cations are precipitated out. After leaching and drying, the powders were calcined in the atmosphere of air/oxygen at 700° C. for 4 h, and then reacted in the dry hydrogen at 1550° C. for 10 minutes to obtain the active substance which is subsequently impregnated into the matrices above at the temperature of 1600° C. for 2 minutes, thus the impregnated yttric Barium-aluminum-scandate cathodes with yttrium oxide-tungsten matrices were obtained.

### Example 6

0.90 g of Gd₂O₃ and 29.10 g of W powders were mixed by a mechanical mixing method, and then the powders were pressed into the pellets with the size of φ3×1.5 mm under the pressure of 4 t/cm². Finally, the pellets were sintered in the atmosphere of hydrogen at 1500° C. for 10 minutes and shaped into the matrices needed. The aqueous solution of 1.37 g of Gd(NO₃)₃.4H₂O, 1.44 g of Sc(NO₃)₃.4H₂O, 25.75 g of Ba(NO₃)₂, 5.82 g of Ca(NO₃)₂.4H₂O, 18.48 g of Al(NO₃)₃.9H₂O and 22.00 g of (NH₄)₂CO₃ was dissolved in the de-ionized water, respectively. The aqueous solution of nitric salt prepared in the first step was mixed together, and then excessive ammonium carbonate solution was titrated into the mixed aqueous solution until all cations are precipitated out. After leaching and drying, the powders were calcined in the atmosphere of air/oxygen at 650° C. for 2 h, and then reacted in the dry hydrogen at 1600° C. for 20 minutes to obtain the active substance which is subsequently impregnated into the matrices above at the temperature of 1600° C. for 3 minutes, thus the impregnated gadolinium-containing Barium-aluminum-scandate cathodes with gadolinium oxide-tungsten matrices were obtained.

### Example 7

1.50 g of Gd₂O₃ and 28.50 g of W powders were mixed by a mechanical mixing method, and then the powders were pressed into the pellets with the size of φ10×1.5 mm under the pressure of 3 t/cm². Finally, the pellets were sintered in the atmosphere of hydrogen at 1550° C. for 15 minutes and shaped into the matrices needed. The aqueous solution of 1.83 g of Gd(NO₃)₃.4H₂O, 2.17 g of Sc(NO₃)₃.4H₂O, 25.21 g of Ba(NO₃)₂, 5.69 g of Ca(NO₃)₂.4H₂O, 18.09 g of Al(NO₃)₃.9H₂O and 22.00 g of (NH₄)₂CO₃ was dissolved in the de-ionized water, respectively. The aqueous solution of nitric salt prepared in the first step was mixed together, and then excessive ammonium carbonate solution was titrated into the mixed aqueous solution until all cations are precipitated out. After leaching and drying, the powders were calcined in the atmosphere of air/oxygen at 750° C. for 3 h, and then reacted in the dry hydrogen at 1600° C. for 10 minutes to obtain the active substance which is subsequently impregnated into the matrices above at the temperature of 1600° C. for 1 minute, thus the impregnated gadolinium-containing Barium-aluminum-scandate cathodes with gadolinium oxide-tungsten matrices were obtained.

### Example 8

2.10 g of Gd₂O₃ and 27.90 g of W powders were mixed by a mechanical mixing method, and then the powders were pressed into the pellets with the size of φ10×1.5 mm under the pressure of 2 t/cm². Finally, the pellets were sintered in the atmosphere of hydrogen at 1600° C. for 20 minutes and shaped into the matrices needed. The aqueous solution of 2.29 g of Gd(NO₃)₃.4H₂O, 2.89 g of Sc(NO₃)₃.4H₂O, 24.66 g of Ba(NO₃)₂, 5.57 g of Ca(NO₃)₂.4H₂O, 17.70 g of Al(NO₃)₃.9H₂O and 22.00 g of (NH₄)₂CO₃ was dissolved in the de-ionized water, respectively. The aqueous solution of nitric salt prepared in the first step was mixed together, and then excessive ammonium carbonate solution was titrated into the mixed aqueous solution until all cations are precipitated out. After leaching and drying, the powders were calcined in the atmosphere of air/oxygen at 850° C. for 4 h, and then reacted in the dry hydrogen at 1500° C. for 30 minutes to obtain the active substance which is subsequently impregnated into the matrices above at the temperature of 1650° C. for 2 minutes, thus the impregnated gadolinium-containing Barium-aluminum-scandate cathodes with gadolinium oxide-tungsten matrices were obtained.

### Example 9

2.70 g of Gd₂O₃ and 27.30 g of W powders were mixed by a mechanical mixing method, and then the powders were pressed into the pellets with the size of φ10×1.5 mm under the pressure of 1.5 t/cm². Finally, the pellets were sintered in the atmosphere of hydrogen at 1500° C. for 15 minutes and shaped into the matrices needed. The aqueous solution of 1.83 g of Gd(NO₃)₃.4H₂O, 4.33 g of Sc(NO₃)₃.4H₂O, 24.39 g of Ba(NO₃)₂, 5.51 g of Ca(NO₃)₂.4H₂O, 17.51 g of Al(NO₃)₃.9H₂O and 22.00 g of (NH₄)₂CO₃ was dissolved in the de-ionized water, respectively. The aqueous solution of nitric salt prepared in the first step was mixed together, and then excessive ammonium carbonate solution was titrated into the mixed aqueous solution until all cations are precipitated out. After leaching and drying, the powders were calcined in the atmosphere of air/oxygen at 950° C. for 5 h, and then reacted in the dry hydrogen at 1550° C. for 30 minutes to obtain the active substance which is subsequently impregnated into the matrices above at the temperature of 1650° C. for 3 minutes, thus the impregnated gadolinium-containing Barium-aluminum-scandate cathodes with gadolinium oxide-tungsten matrices were obtained.

### Example 10

3.00 g of Gd₂O₃ and 27.00 g of W powders were mixed by a mechanical mixing method, and then the powders were pressed into the pellets with the size of φ10×1.5 mm under the pressure of 4 t/cm². Finally, the pellets were sintered in the atmosphere of hydrogen at 1550° C. for 10 minutes and shaped into the matrices needed. The aqueous solution of 1.37 g of Gd(NO₃)₃.4H₂O, 3.61 g of Sc(NO₃)₃.4H₂O, 24.94 g of Ba(NO₃)₂, 5.63 g of Ca(NO₃)₂.4H₂O, 17.90 g of Al(NO₃)₃.9H₂O and 22.00 g of (NH₄)₂CO₃ was dissolved in the de-ionized water, respectively. The aqueous solution of nitric salt prepared in the first step was mixed together, and then excessive ammonium carbonate solution was titrated into the mixed aqueous solution until all cations are precipitated out. After leaching and drying, the powders were calcined in the atmosphere of air/oxygen at 700° C. for 4 h, and then reacted in the dry hydrogen at 1600° C. for 20 minutes to obtain the active substance which is subsequently impregnated into the matrices above at the temperature of 1600° C. for 1 minute, thus the impregnated gadolinium-containing Barium-aluminum-scandate cathodes with gadolinium oxide-tungsten matrices were obtained.

The maximum secondary emission yield obtained from Examples 2-5 and 7-10 are summarized in Table 1.

TABLE 1
The maximum secondary emission yield δₘₐₓ
obtained from Examples 2-5 and 7-10

| Samples | δₘₐₓ |
|---|---|
| Example 2 | 2.87 |
| Example 3 | 3.14 |
| Example 4 | 3.38 |
| Example 5 | 3.51 |
| Example 7 | 2.98 |
| Example 8 | 3.21 |
| Example 9 | 3.63 |
| Example 10 | 3.87 |

1. An impregnated rare earth-containing barium-aluminum-scandate cathode, comprising:
a first rare earth oxide doped tungsten matrix; and
an impregnated active substance that comprises scandium oxide (Sc₂O₃), a second rare earth oxide, and Barium-calcium-aluminate, wherein the molar ratio of Ba:Ca:Al is about 4:1:1.

2. The impregnated rare earth-containing Barium-aluminum-scandate cathode of claim 1, wherein the concentration of the first rare earth oxide ranges from 3 to 10% by weight.

3. The impregnated rare earth-containing Barium-aluminum-scandate cathode of any of claims 1 and 2, wherein the first rare earth oxide is yttrium oxide(Y₂O₃) or gadolinium oxide (Gd₂O₃).

4. The impregnated rare earth-containing Barium-aluminum-scandate cathode of claim 1, wherein the concentration of the Sc₂O₃ ranges from 2 to 6% by weight.

5. The impregnated rare earth-containing Barium-aluminum-scandate cathode of claim 1, wherein concentration of the second rare earth oxide ranges from 3 to 5% by weight.

6. An impregnated rare earth-containing Barium-aluminum-scandate cathode of any of claims 1 and 5, wherein the second rare earth oxide is Y₂O₃ or Gd₂O₃.

7. An impregnated rare earth-containing Barium-aluminum-scandate cathode, comprising:
a first rare earth oxide doped tungsten matrix; and
an impregnated active substance that comprises scandium oxide (Sc₂O₃),
a second rare earth oxide, and Barium-calcium-aluminate;
wherein the first and the second rare earth oxides are yttrium oxide(Y₂O₃) or gadolinium oxide (Gd₂O₃);

8. The impregnated rare earth-containing Barium-aluminum-scandate cathode of claim 7, wherein the concentration of the first rare earth oxide in the matrix ranges from 3 to 10% by weight.

9. The impregnated rare earth-containing Barium-aluminum-scandate cathode of claim 7, wherein the active substance comprises 2 to 6% by weight of Sc₂O₃, 3 to 5% by weight of Y₂O₃ or Gd₂O₃, and Barium-calcium-aluminates in the molar ratio of Ba:Ca:Al of 4:1:1.

10. A method for making an impregnated rare earth-containing Barium-aluminum-scandate cathode with a rare earth oxide doped tungsten matrix, comprising:
mixing a rare earth oxide with a tungsten powder;
pressing the mixed powders into pellets under a pressure between 1.5 t/cm² to 4 t/cm²;
sintering the pellet under hydrogen at a temperature between 1500° C. and 1600° C. for 10 to 20 minutes to obtain a matrix;
dissolving a raw material comprising scandium nitrate, barium nitrate, calcium nitrate, aluminum nitrate, and rare earth nitrate in de-ionized water to obtain a raw material solution;
titrating an excess amount of aqueous ammonium carbonate solution into the raw material solution until all cations are precipitated out;
leaching the precipitated solid;
drying the solid;
calcining the dried solid under air/oxygen at a temperature between 650° C. and 950° C. for 2 to 5 hours;
reacting the calcined solid under dry hydrogen at a temperature between 1500° C. and 1600° C. for 10 to 30 minutes to obtain an impregnated active substance; and
impregnating the active substance into the matrix under hydrogen at a temperature between 1600° C. and 1650° C. for 1 to 3 minutes.

11. The method of claim 10, wherein the concentration of the rare earth oxide ranges from 3 to 10% by weight.

12. The method of any of claims 10 and 11, wherein the rare earth oxide is yttrium oxide(Y₂O₃) or gadolinium oxide (Gd₂O₃).

13. The method of claim 10, wherein the rare earth nitrate is yttrium nitrate, or gadolinium nitrate.

14. The method of claim 10, wherein the raw materials correspond to 2 to 6% by weight of Sc₂O₃, 3 to 5% by weight of Y₂O₃ or Gd₂O₃, and Barium-calcium-aluminate in the molar ratio of Ba:Ca:Al of 4:1:1.

15. A method for making a rare earth oxide doped tungsten matrix, comprising:
mixing a rare earth oxide power and a tungsten powder;
pressing the mixed powders into pellets; and
sintering the pellet to obtain a matrix.

16. The method of claim 15, wherein the concentration of the rare earth oxide ranges from 3 to 10% by weight.

17. The method of claim 15, where in the rare earth oxide powder and the tungsten power are mixed by mechanical mixing method.

18. The method of any of claims of 15-17, wherein the rare earth oxide is yttrium oxide (Y₂O₃), or gadolinium oxide (Gd₂O₃).

19. The method of claim 15, wherein the mixed powders is pressed under a pressure between 1.5 t/cm² to 4 t/cm².

20. The method of claim 15, wherein the pellet is sintered under hydrogen at a temperature between 1500° C. and 1600° C. for 10 to 20 minutes.

21. A method for making an impregnated active substance, comprising:
dissolving the raw materials comprising scandium nitrate, barium nitrate calcium nitrate, aluminum nitrate, and rare earth nitrate in de-ionized water to obtain a raw material solution;
titrating an excess amount of aqueous ammonium carbonate solution into the raw material solution until all cations are precipitated out;
leaching the precipitated solid from the solution;
drying the solid;
calcining the dried solid; and
reacting the calcined solid under dry hydrogen.

22. The method of claim 21, wherein the rare earth nitrate is yttrium nitrate, or gadolinium nitrate.

23. The method of claim 21, wherein the raw materials correspond to 2 to 6% by weight of Sc₂O₃, 3 to 5% by weight of Y₂O₃ or Gd₂O₃, and Barium-calcium-aluminate in the molar ratio of Ba:Ca:Al of 4:1:1.

24. The method of claim 21, wherein the solid is calcined under air/oxygen at a temperature between 650° C. and 950° C. for 2 to 5 hours

25. The method of claim 21, wherein the solid is reacted under dry hydrogen at a temperature between 1500° C. and 1600° C. for 10 to 30 minutes.

26. A method for making an impregnated rare earth-containing Barium-aluminum-scandate cathode with a rare earth oxide doped tungsten matrix, comprising impregnating the active substance of claim 21 into the matrix of claim 15 under hydrogen at a temperature between 1600° C. and 1650° C. for 1 to 3 minutes.
